(19) United States
(12) Patent Application Publication
(10) Pub. No.: US 2008/0276715 A1
(43) Pub. Date: Nov. 13, 2008

(54) Handrail testing device

(76) Inventor: Louis Tombazzi, Strongsville, OH (US)

Correspondence Address: MCDONALD HOPKINS LLC, 600 Superior Avenue, East, Suite 2100, CLEVELAND, OH, 44114-2653, US

(21) Appl. No.: 12/150,891

(22) Filed: Apr. 30, 2008

Related U.S. Application Data
(60) Provisional application No. 60/926,857, filed on Apr. 30, 2007.

(51) Int. Cl. G01L 5/00

(52) U.S. Cl. 73/760

(57) ABSTRACT

A handrail testing device having a lever arm having a first end and a second end, a mounting portion connected to the lever arm capable of pivotally securing the first end on or near a handrail, a load portion connected to the lever arm and capable of engaging the handrail to transmit a force applied to the second end of the lever arm to the handrail, and a measurement portion connected to the lever arm.

### CROSS-REFERENCE TO RELATED APPLICATIONS

This application claims benefit to provisional application No. 60/926,857, entitled “APPARATUS AND METHODS FOR MEASURING AND TESTING HANDRAILS,” filed Apr. 30, 2007, which is hereby incorporated in its entirety by reference.

### FIELD OF THE INVENTION

The present invention generally relates to a testing device for handrails, and more particularly, to a device for testing and measuring multiple aspects of handrails.

### BACKGROUND OF THE INVENTION

Handrails are structures that include one or more railings and are typically affixed to walls, posts, floors, and the like. Handrails are positioned to be manually grasped by people passing by the handrail to provide support and stability. Such handrails are often positioned to assist people in traversing steps, hallways, balconies, and other similar locations where extra care is taken to avoid stumbles or falls, which may lead to injuries.

To properly design, manufacture, and install a handrail, the handrail industry must conform to a myriad a government and industry laws, regulations, rules, guidelines, and other such standards. Accordingly, once a handrail is installed in a particular location, comprehensive testing of the installed handrail is required to determine if the installed handrail satisfies government and industry standards. In addition, customers may desire additional requirement for installed handrails, which leads to additional testing.

In the field, testing of installed handrails is typically performed by a certified testing agency. Additionally, manufactures, distributors, and installers often retain an engineering consultant to perform pre-testing of the handrails to ensure the handrails will meet required standards upon installation. In the instance where a specific handrail or handrail design fails to meet the required standards, engineering consultants must be further retained to conduct additional testing on reconfigured or redesigned handrails to insure compliance with required standards.

The process of retaining outside certification agencies and consultants to insure handrails are properly designed, manufactured, and installed adds significant cost to the handrail industry. As certain tests must be performed in the field, i.e., at the location of the handrail installation, certified agency testers and engineering consultants are customarily compensated for traveling time and costs. Such field-testing only increases the costs of designing, manufacturing, and installing handrails.

The handrail industry may alternatively perform testing without the use of certification agencies and consultants by hiring permanent employees and purchasing equipment to perform handrail testing. However, a large number of gauges and other such equipment would need to be purchased to perform tests that verify the many requirements. In addition, the employees hired to use such equipment need to be relatively skilled. As will be readily understood, investments in additional skilled employees and a large inventory of gauges and measurement devices add costs to the handrail industry.

Accordingly, there is a need in the industry for a device that simplifies and reduces costs of performing handrail measurements and testing during the design, manufacturing, and field installation of handrails. Specifically, there is a need for relatively inexpensive device designed to measure and test multiple aspects of a handrail. Additional information will be set forth in the description which follows, and in part will be obvious from the description, or may be learned by practice of the invention.

### SUMMARY OF THE INVENTION

A handrail testing device is provided having a lever arm having a first end and a second end, a mounting portion connected to the lever arm capable of pivotally securing the first end on or near a handrail, a load portion connected to the lever arm and capable of engaging the handrail to transmit a force applied to the second end of the lever arm to the handrail, and a measurement portion connected to the lever arm.

In another aspect, a handrail testing device is provided having a lever arm having a first end and a second end, a first mounting portion connected to the lever arm and capable of pivotally securing the first end of the lever arm on or near a handrail, a first load portion connected to the lever arm, wherein a force applied to the second end of the lever arm is transmitted from the first load portion to the handrail, a second mounting portion connected to the lever arm and capable of pivotally securing the first end of the lever arm on or near the handrail, and a second load portion connected to the lever arm, wherein a force applied to the second end of the lever arm is transmitted from the second load portion to the handrail.

Additional features and advantages of the invention will be set forth in the description that follows, and in part will be apparent from the description, or may be learned by practice of the invention. The objectives and other advantages of the invention will be realized and attained by the structure particularly pointed out in the written description and claims hereof as well as the appended drawings. It is to be understood that both the foregoing general description and the following detailed description are exemplary and explanatory and are intended to provide further explanation of the invention as claimed.

### DESCRIPTION OF THE DRAWINGS

Operation of the invention may be better understood by reference to the following detailed description taken in connection with the following illustrations, wherein.

FIG. 1 illustrates a preferred embodiment of a handrail testing device positioned to measure a clearance between a handrail and a wall;

FIG. 2 illustrates a preferred embodiment of a handrail testing device positioned to measure a distance between pickets of a handrail;

FIG. 3 illustrates a preferred embodiment of a handrail testing device positioned to test a load capacity of an installed handrail;

FIG. 4 illustrates a preferred embodiment of a handrail testing device positioned to test a load capacity of an installed handrail;

FIG. 5 illustrates a preferred embodiment of a handrail testing device positioned to test a load capacity of an installed handrail;

FIG. 6 illustrates a preferred embodiment of a handrail testing device positioned to test a load capacity of an installed handrail;

FIG. 7 illustrates a preferred embodiment of a handrail testing device positioned to test a load capacity of an installed handrail;

FIG. 8 illustrates a preferred embodiment of a handrail testing device positioned to measure a height of a handrail;

FIG. 9 illustrates a preferred embodiment of a handrail testing device positioned to measure a height of a handrail;

FIG. 10 illustrates a preferred embodiment of a handrail testing device positioned to measure a height of a handrail;

FIG. 11 illustrates a preferred embodiment of a handrail testing device positioned to measure a diameter of a handrail;

FIG. 12 illustrates a preferred embodiment of a handrail testing device positioned to measure a distance between center posts of a handrail;

FIG. 13 illustrates a preferred embodiment of a handrail testing device positioned to measure the levelness of a handrail;

FIG. 14 illustrates a preferred embodiment of a handrail testing device positioned to measure the vertical plumb of a handrail; and

FIG. 15 illustrates a preferred embodiment of a handrail testing device positioned to measure the vertical plumb of a handrail.

### DETAILED DESCRIPTION OF THE PREFERRED EMBODIMENTS

While the present invention is described with reference to the embodiments described herein, it should be clear that the present invention should not be limited to such embodiments. Therefore, the description of the embodiments herein is illustrative of the present invention and should not limit the scope of the invention as claimed.

Reference will now be made in detail to embodiments as illustrated in the accompanying figures. The present handrail testing device is configured to perform a wide variety of measurements and tests directed to determining the capabilities and characteristics of a handrail. Such capabilities and characteristics may be compared to a set of required standards to determine if a handrail meets those standards. The handrail testing device achieves its versatility by the incorporation of many measurement or testing devices into one device.

The variety of measurements and tests performed on a handrail may, for example, include, but is not limited to: measuring the dimensions of a handrail and its subcomponents; testing the strength of the handrail; testing the strength of the anchoring system used to install the handrail to a wall, post, or floor, and measuring the position of the handrail as installed relative to a wall, post, or floor.

Throughout the detailed description, handrail testing device may be referred to as handrail gauges for convenience. The phrase handrail gauge will not be read to limit the scope of the invention in anyway. As will be readily apparent from a reading of the detailed description and the accompanying figures, a handrail gauge is capable of performing tests and measurements that are broader than a plain meaning of the term “gauge.”

The versatility of a handrail gauge may lessen the reliance on or eliminate the need for the retaining of engineering consultants to test and measure handrails during the design and manufacture of handrails. In addition, a handrail gauge may also lessen the reliance on or eliminate the need for a certification agency to measure and test an installed handrail to certify that the handrail meets needed requirements.

As the present handrail gauge may integrate several measuring and testing devices therein, it relieves the need to purchase or otherwise obtain the variety of individual gauges or instruments needed to perform the measurements or testing required to insure a handrail meets the needed requirements. The handrail gauge may be arranged to be lightweight and compact such that it is portable by an individual. Such portability allows for quick and hassle-free movement of a handrail gauge between a variety of locations such as, for example, handrail design facilities, handrail manufacturing facilities, and installation locations. Such easy movement creates significant flexibility for the use of handrail gauges.

The lightweight and compact structure of a handrail gauge increases the ease of use of the handrail gauge. Generally, the handrail gauge may be arranged to allow a sole operator to transport the handrail gauge between locations, and a sole operator may use the handrail gauge to perform measurements and tests on a handrail.

The handrail gauge may be arranged for use with any type and configuration of handrail or handrails made of any type of material. In a non-limiting example, handrails may include one or more rails, crossbars, pickets, posts, spindles, and the like. Further, the handrail gauge may be arranged to measure and test handrails formed, constructed, or fabricated from wood, plastic, stainless steel, aluminum, bronze, other metals, and the like. In addition, a handrail gauge may be configured for use with structures other than handrails. For example, the handrail gauge may be arranged to be used to measure and test ramps, stairs, bridges, platforms, walkways, and the like.

As will be further described and shown, typical measurements and tests performed by a handrail gauge include, but are not limited to: (1) measurement of finger clearance between a handrail and a wall or post; (2) measurement of spacing between pickets of a handrail; (3) measurement of spacing between a picket of a handrail and an adjacent wall or post; (4) measurement of weight loads applied to a top rail, grab rail, or other rail of a handrail; (5) measurement of a maximum height of a handrail or grab rail; (6) measurement of a minimum height of a handrail or grab rail; (7) measurement of a width or diameter of a rail of a handrail; (8) testing of a handrail to determine if it withstands a specified lateral or vertical load; and (9) measurement of the levelness of a handrail.

As is illustrated in the figures and will be described in detail below, an embodiment of a handrail gauge includes a number of attachments and features that facilitate performing a variety of measurements and tests on handrails. As seen throughout the figures, a handrail gauge 10 may be provided with a lever arm or body 12 having a first end 12A and a second end 12B, a first mounting portion 14 coupled to the body 12 by a pivoting arm 16, a second mounting portion 18 moveably coupled to the body 12, a bracket member 20 moveably coupled to the body 12, a handle 22 extending from the body 12, a gauge level dial 24 mounted to the body 12, a third mounting portion 26 moveably coupled to the body 12, and a fourth mounting portion 28 coupled to the body 12.

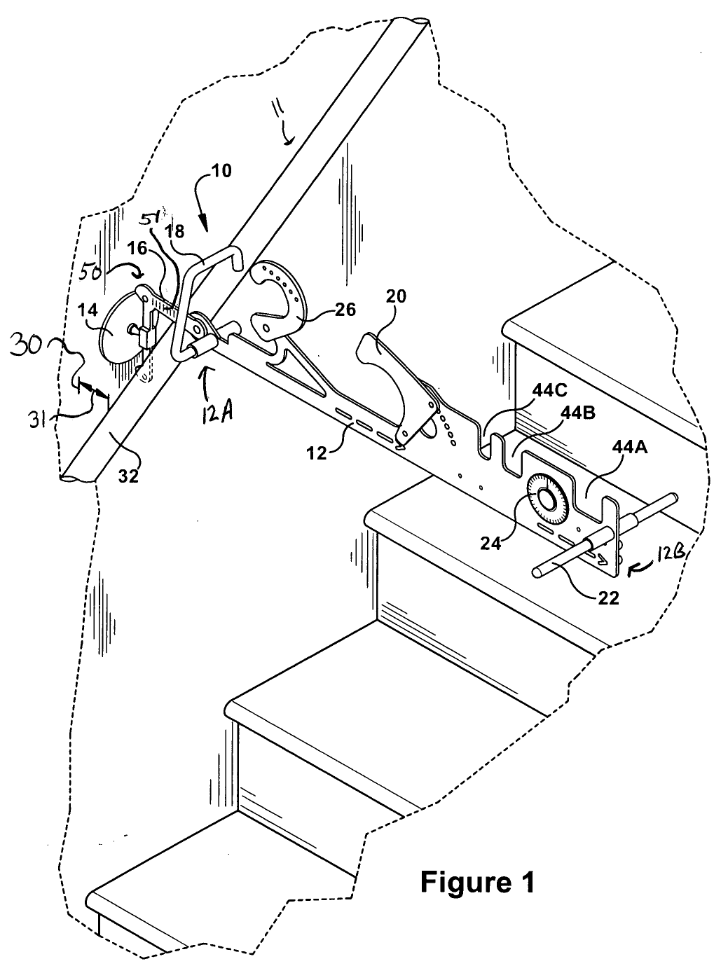

With reference to FIG. 1, an embodiment of a handrail gauge 10 is arranged to measure finger clearance 31 between a wall 30 and a rail 32 of an installed handrail 11. Handrail standards often mandate a minimum clearance between a wall or post and the inside of an installed rail. For example, a regulation may mandate that the finger clearance from a rail to a wall or post be a minimum of 1.5 inches along the length of the rail. In a non-limiting example as shown in FIG. 1, the handrail gauge 10 may be provided with a measurement portion 50 connected to the body for measuring the clearance 31. The measurement portion 50 may include the first mounting portion 14 and the pivoting arm 16. To measure the clearance 31, the first mounting portion 14 may be positioned against a wall 30. It is to be understood that although shown as a disk shape, the first mounting portion 14 may be any shape positionable along a wall. The pivoting arm 16 may be provided with markings 51 indicating the distance from the wall 30, to allow an operator to visually determine the clearance 31 between the inside of the rail 32 and the wall 30. The determined clearance 31 may be compared to the handrail requirements to determine whether the installed handrail 11 meets the requirements.

When the handrail gauge 10 is arranged to measure finger clearance, as shown in FIG. 1, the pivoting arm 16 may be locked into place with respect to the body 12. In such an arrangement, the operator may slide the handrail gauge 10 along the length of the rail 32 and continuously monitor the clearance 31 between the rail 32 and the wall 30. Such an operation allows the operator to determine whether an installed handrail 11 meets a requirement of, for example, having a continuous finger clearance of 1.5 inches along the length of the rail 32.

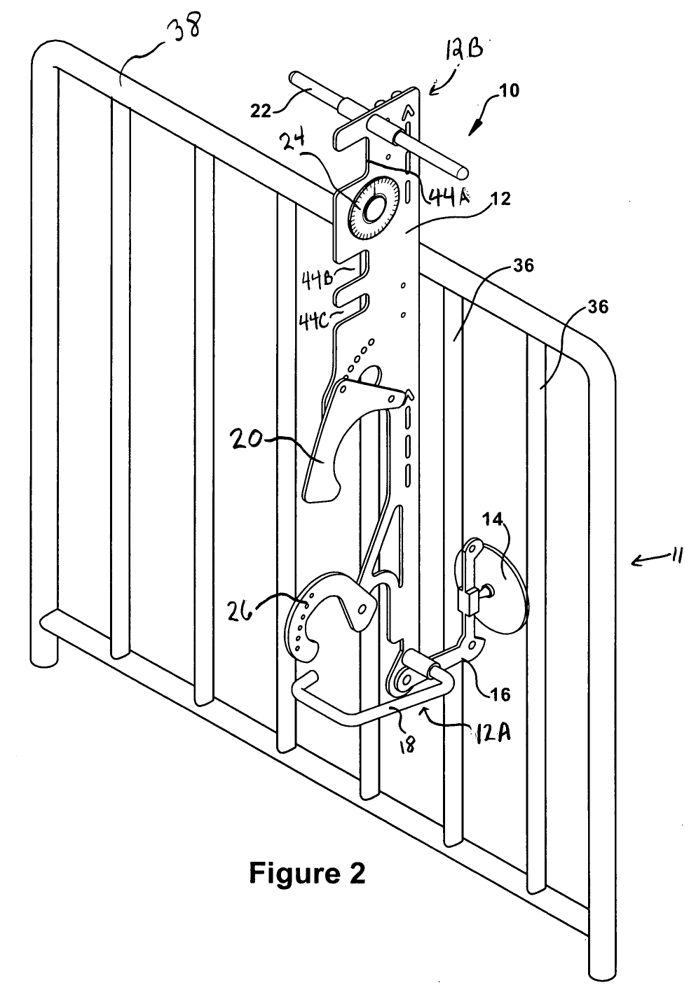

FIG. 2 illustrates an embodiment of a handrail gauge 10 arranged to measure the distance between two adjacent pickets 36 of a handrail. As used herein, the term picket or pickets may include, but is not limited to, spindles, posts, end posts, center posts, crossbars, and the like. It is also to be understood that the pickets 36 may be arranged in any orientation. Handrail standards often mandate that there is a maximum distance between components in a handrail. For example, standards may dictate that the be a maximum of four inches between adjacent pickets of a handrail, an end picket and a post or wall, or a glass panel and top caps or end pickets. As can be seen in FIG. 2, the handrail gauge 10 may be positioned such that the first mounting portion 14 is aligned with an opening between two adjacent pickets 36. In a non-limiting example, the first mounting portion 14 may have a diameter of four inches. Thus, if the first mounting portion 14 is able to pass through the opening between adjacent pickets 36, an operator may quickly determine that the handrail 11 does not meet the four-inch maximum requirement. As will be readily understood, a similar operation may be performed to evaluate openings between an end picket and a post or wall or between a glass panel and a top cap or end picket.

Optionally, the first mounting portion 14 may be arranged to be detachable and exchangeable with differently sized and shaped mounting or measurement portions. In such an arrangement, a mounting or measurement portion matching the specific maximum distance requirement may be coupled to the body 12 to facilitate efficient measurement of openings between pickets, glass panels, etc.

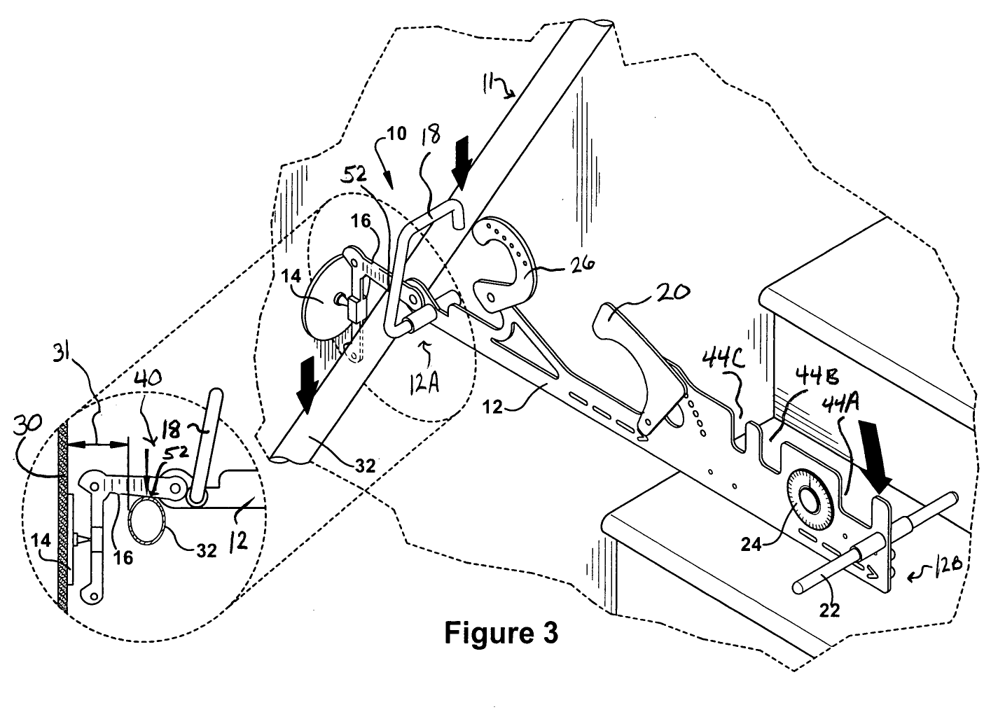

FIG. 3 illustrates an embodiment of a handrail gauge 10 arranged to test whether an installed handrail 11 is capable of withstanding a required load applied to a rail 32. Handrail standards often mandate that an installed handrail be capable of withstanding a minimum load, for example a 200-pound load. As is shown in FIG. 3, the first mounting portion 14 is placed against an installation wall 30 to pivotally secure the first end 12A so that the body 12 is positioned in a substantially horizontal orientation. As positioned, a first load portion 52 may be in contact with the rail 32. The pivoting arm 16 is locked so that the operator may take a zero reading of the gauge level dial 24 attached to the body 12. The level dial 24 may include markings to indicate the angle of the body 12 with respect to a horizontal plane.

The operator may apply a downward force at the second end 12B of the body 12, with for example, the handle 22. The handle 22 may be extendable to increase the length of the body 12 to provide more leverage. Accordingly, first load portion 52 engages the rail 32 to transmit the downward force, or load, to the rail 32. Accordingly, the body 12 is used as a lever to multiply the load applied to the rail 32. The handrail gauge 10 may be arranged such that a two-degree decline in the body 12, as indicated by the gauge level dial 24, corresponds to a 200-pound load applied on the rail 32. The operator may monitor the two-degree decline by observing the gauge level dial 24, which may include markings indicating when the handrail gauge 10 is two degrees declined from the zero reading. It will be readily understood that an arrangement where a two-degree decline equates to a 200-pound load on a rail is exemplary only. The handrail gauge 10 may be arranged such that any degree of decline may equate to a 200-pound load or a two-degree decline may equate to a load on the rail that is greater or less than 200 pounds. Further, it is to be understood that the gauge level dial 24 may be any indicator capable of indicating the load applied to a handrail 11. In a non-limiting example, the gauge level dial 24 may be a torque wrench.

The arrangement of the handrail gauge 10 as exemplarily illustrated in FIG. 3 may apply to a variety of configurations of handrails. For example, the arrangement may apply to rails of any height such as, for example, rails positioned at thirty-two inches, thirty-six inches, or forty-two inches above the ground. In addition, the arrangement may apply to rails secured to walls, posts, guardrails, and the like.

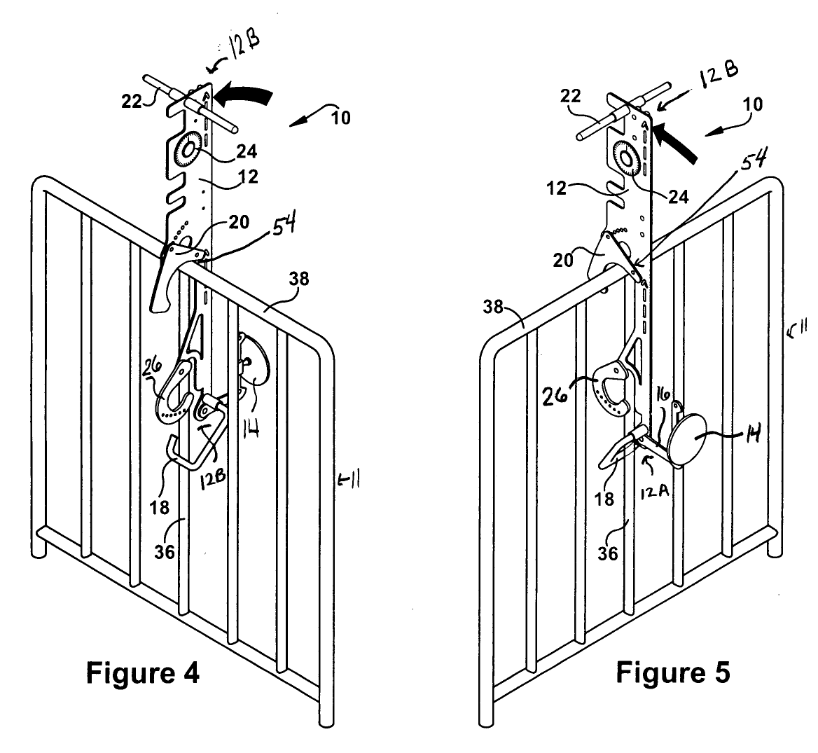

FIGS. 4 and 5 illustrate an embodiment of a handrail gauge 10 arranged to test whether an installed handrail 11 is capable of withstanding a required load applied to the rail 38. Handrail standards often mandate that an installed handrail be capable of withstanding a minimum load, for example a 200-pound load. As is shown in FIGS. 4 and 5, a second mounting portion 18 is placed around, or otherwise connected to, a picket 36 of the handrail to pivotally secure the first end 12A such that the body 12 is oriented in a substantially vertical orientation. It is understood, that although the second mounting portion 18 is shown as pivotally securing the first end 12A to a vertical picket 36, one of ordinary skill in the art will appreciate that the second mounting portion 18 may be any shape or configuration capable of pivotally securing the first end 12A to a horizontal picket (not shown). The third mounting portion 26 may also be provided for pivotally securing the first end 12A to a horizontal picket (not shown). The second mounting portion 18 may have a hook shape; although one of ordinary skill in the art will appreciate that a variety of other shapes may be used. Accordingly, the body 12 is positioned substantially vertically with a second load portion 54 adjacent to the top rail 38. The bracket member 20 may be placed over the rail 38 to stabilize and position the handrail gauge 10. The operator may adjust the positioning of the body 12 and insure the body 12 is positioned vertically by observing readings on the gauge level dial 24. Such a vertical orientation of the body 12 allows a user, for example, to apply a load to a handrail in areas of limited space where a load could not be applied, or would be difficult to be applied, with a lever in a horizontal orientation.

The operator may take a zero reading of the gauge level dial 24 attached to the body 12 and apply a lateral force at the second end 12B of the body 12. The second load portion 54 engages the rail 38 to transmit the force, or load, to the rail 38. Accordingly, the body 12 is used as a lever to multiply the load applied to the rail 38. The handrail gauge 10 may be arranged such that a two-degree change in the position of the body 12, indicated by the gauge level dial 24 (as described above), corresponds to a 200-pound load applied to the rail 38. The operator may monitor the two-degree decline by observing the gauge level dial 24. It will be readily understood that an arrangement where a two-degree change in position equates to a 200-pound load on the rail is exemplary only. The handrail gauge 10 may be arranged such that any degree of change may equate to a 200-pound load on a rail or a two-degree change may equate to a load that is greater or less than 200 pounds.

The arrangement of the handrail gauge 10 as exemplarily illustrated in FIGS. 4 and 5 may apply to a variety of configurations of handrails. For example, the arrangement may apply to rails of any height such as, for example, rails positioned at thirty-two inches, thirty-six inches, or forty-two inches above the ground. In addition, the arrangement may apply to rails secured to walls, posts, or guardrails.

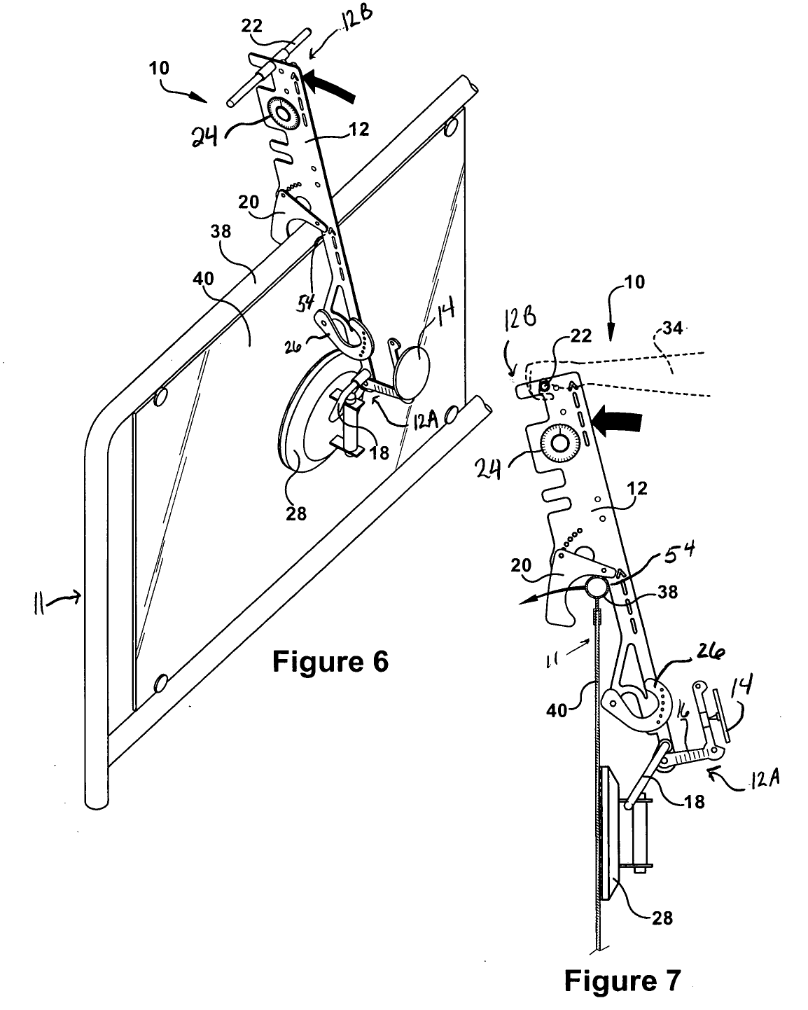

FIGS. 6 and 7 illustrate an embodiment of a handrail gauge 10 arranged to test the resistance of an installed handrail 11 to a load applied to the rail 38, where the handrail does not include pickets. The handrail 11 as shown includes a glass panel 40 in place of traditional pickets. The handrail gauge 10 is generally arranged as shown in FIGS. 4 and 5; however, a fourth securing member 28, such as a suction cup, is attached to the glass panel 40 to provide an anchor to which the body 12 of the handrail gauge 10 may be attached to pivotally secure the first end 12A. The suction cup 28 may be attached to the body 12, for example, with the second mounting portion 18. It is understood, however, that the suction cup 28 may be removeably secured to the body 12 in a variety of configurations. In the arrangement shown in FIGS. 6 and 7, the operator 34 may push or pull the second end 12B toward the rail 38 until an appropriate load, such as a 200-pound load is applied via the second load portion 54 to the rail 38.

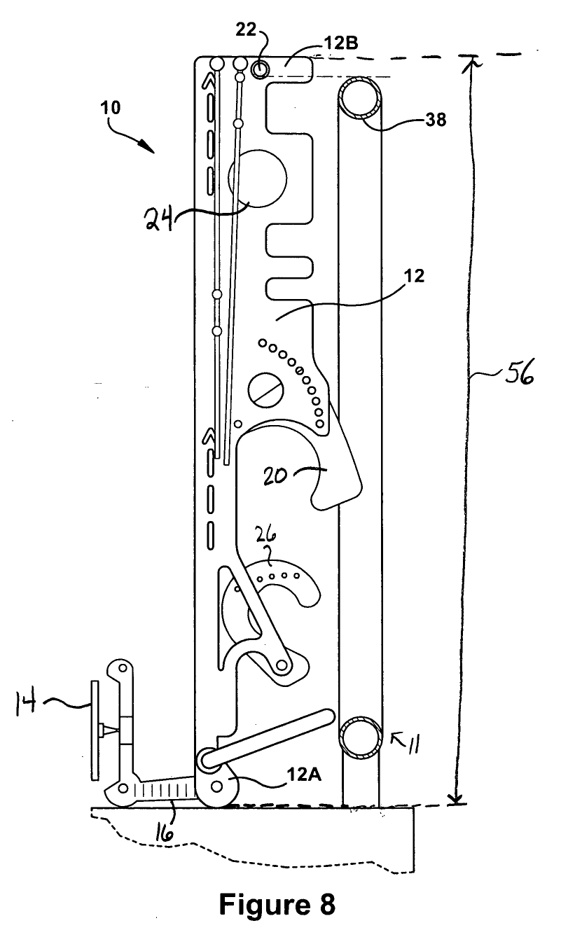

The handrail gauge 10 may be arranged to determine whether the height of an installed handrail meets a minimum or maximum requirement. Handrail standards often mandate, for example, that a top rail or grab rail of a handrail be installed at a minimum or maximum distance above the ground or floor. For example, handrail standards may require that a top rail be positioned a minimum of thirty-six inches above the ground or a grab rail be positioned thirty-two inches or, alternatively, forty-two inches, above the ground. As illustrated in FIGS. 8 through 10, the handrail gauge 10 may be configured to measure or test of such requirements.

FIG. 8 illustrates an embodiment of a handrail gauge 10 provided with a second measurement portion 56 capable of determining whether a rail 38, such as a top rail, of a handrail 11 is a minimum of thirty-six inches off the ground. The handrail gauge 10 may be arranged such that the second measurement portion 56 includes the overall length of the body 12, which may be thirty-six inches. Thus, placing the first end 12A of the body 12 on the ground and positioning the body 12 vertically against the handrail 11 will place the second and opposite end 12B of the body 12 proximate to the rail 38. The operator 34 may compare the height of the second end 12B, which is thirty-six inches off the ground, with the height of the rail 38. The operator 34 may determine whether the handrail 11 meets the necessary requirement through such a comparison. The operator 34 may observe the gauge level dial 24 in insuring that the handrail gauge 10 is indeed vertically positioned during the measurement of the rail 38 height.

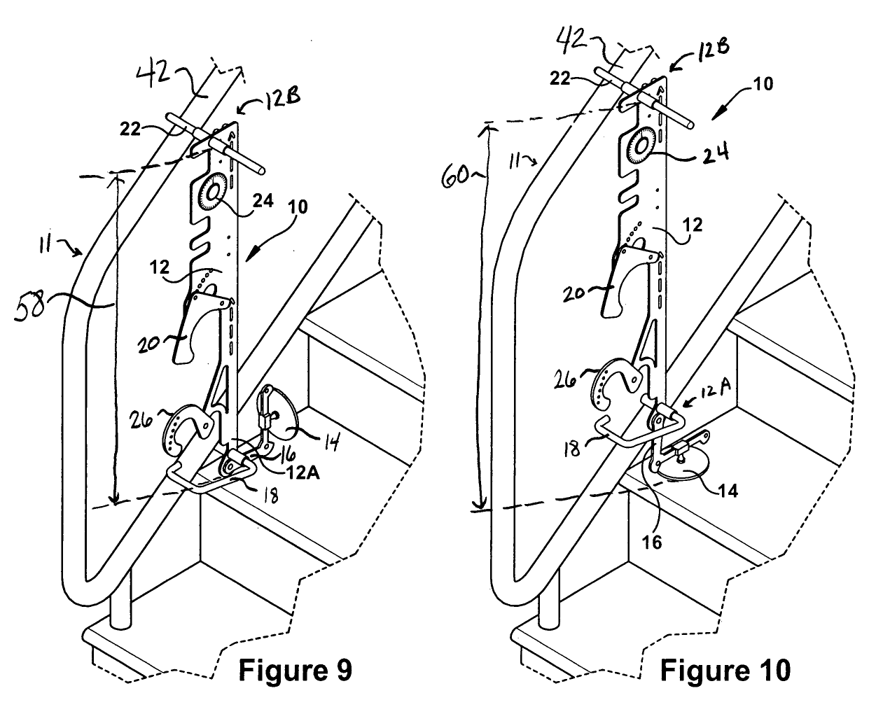

Similar to the description of FIG. 8, FIGS. 9 and 10 illustrate the measurement of a rail 42, such as a grab rail, to determine whether the rail 42 heights are, for example, thirty-two inches and forty-two inches of the ground, respectively. In FIG. 9, the handrail gauge 10 is provided with a third measurement portion 58 comprising a portion of the length of the body 12, such as the distance from the first end 12A of the body 12 to the handle 22, which may, for example, be thirty-two inches. Thus, as the first end 12A of the body 12 is positioned on the ground (or step, as shown in FIG. 9) and the body 12 is positioned vertically, the handle 22 stands thirty-two inches off the ground. In such an arrangement, the operator 34 may observe the relative heights of the rail 42 and the handle 22 in determining whether the rail 42 meets a thirty-two inch minimum height requirement.

In FIG. 10, the pivoting arm 16 is positioned such that the first mounting portion 14 extends from the first end 12A of the body 12. A fourth measurement portion 60 is provided that may comprise the distance from the first mounting portion 14 to the handle 22, which may be forty-two inches. Thus, when the first mounting portion 14 is positioned on the step and the body 12 is vertically positioned, the handle 22 is elevated to forty-two inches off the ground. The operator positions the handrail gauge 10 such that the handle 22 is proximate to the rail 42. In such an arrangement, the operator may observe the relative heights of the rail 42 and the handle 22 to determine whether the rail 42 meets a forty-two inch minimum height requirement.

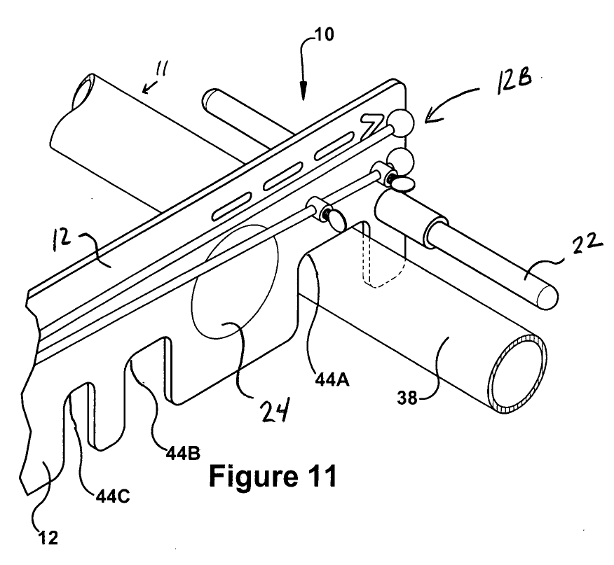

FIG. 11 illustrates an embodiment of a handrail gauge 10 arranged to determine if the diameter of a rail 38 of a handrail is within specified standards. Handrail standards often mandate that the diameter of a rail be between minimum and maximum sizes such as, for example, between 1.25 inches and 2.25 inches. The body 12 may include a series of differently sized measurement portions 44A, 44B, and 44C, such as notches, for measuring the diameter of a rail. As shown in FIG. 11, the handrail gauge 10 is arranged such that one of the notches 44A is positioned about the rail 38. In such an arrangement, the operator may observe if the rail 38 fits into the notch 44A to determine if the diameter of the rail 38 is larger or smaller than the notch 44A. By attempting to position a number of notches 44 over the rail 38, the operator may determine whether the diameter requirement is met. For example, the operator may attempt to place both a 1.25-inch notch and a 2.25-inch notch over the rail 38. If the 1.25-inch notch does not fit over the rail 38 and the 2.25-inch notch does fit over the rail 38, the operator may determine the rail 38 meets the handrail standards. If this is not the case, the operator may determine the rail 38 fails to meet the handrail standards.

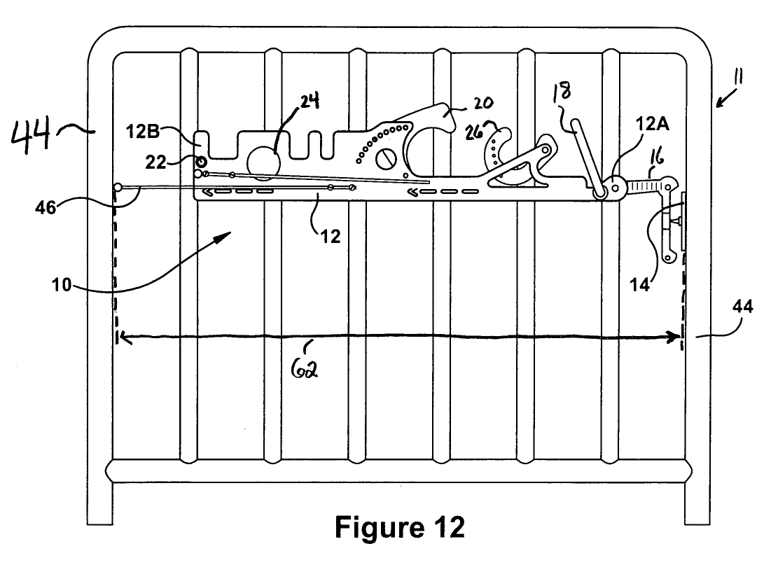

FIG. 12 illustrates an embodiment of a handrail gauge 10 provided with a measurement portion 62 for determining the distance between end or center posts 44 of a handrail. Handrail standards often mandate a maximum distance between center posts in a handrail. For example, the maximum distance may be set to four feet. The handrail gauge 10 may be arranged such that the first mounting portion 14 is positioned to extend from the first end 12A of the body 12 and a rod 46 positioned to extend from the second end 12B of the body 12, to form the measurement portion 62. In such an arrangement, the measurement portion 62 comprises the overall length of the handrail gauge 10 from the first mounting portion 14 to the end of the rod 46, which may be four feet. As shown in FIG. 12, the operator may position such an arranged handrail gauge 10 between center posts 44 of a handrail. By comparing the four foot overall length of the measurement portion 62 with the distance between the center posts 44, the operator may determine if the distance between center posts 44 is greater than or less than four feet. It is to be understood that the measurement portions 56, 58, 60, and 62 are not limited to the configurations described above, as one of ordinary skill in the art will appreciate upon reading the present description that a variety of configurations and markings may be used.

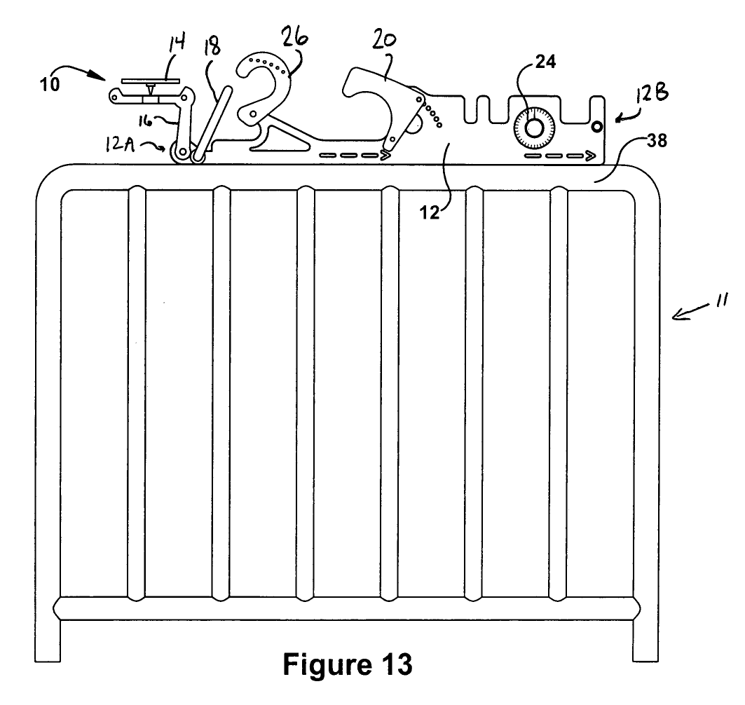

FIG. 13 illustrates an embodiment of a handrail gauge 10 arranged to determine if the rail 38 of a handrail is level. The operator may position the handrail gauge 10 along the top surface of the rail 38. The gauge level dial 24 may be arranged with markings to indicate when the handrail gauge 10 is positioned level with respect to a horizontal plane. The operator may observe the gauge level dial 24 as the handrail gauge 10 is positioned along the surface of the rail 38 to determine if the rail 38 is level. If the rail 38 is not level, the gauge level dial 24 may be arranged to indicate the angle of the top rail 38 with respect to a horizontal plane. It is to be understood, however, that a present handrail gauge 10 is not limited to a specific level indicator, as one of ordinary skill in the art will appreciate that a variety of level indicators may be used.

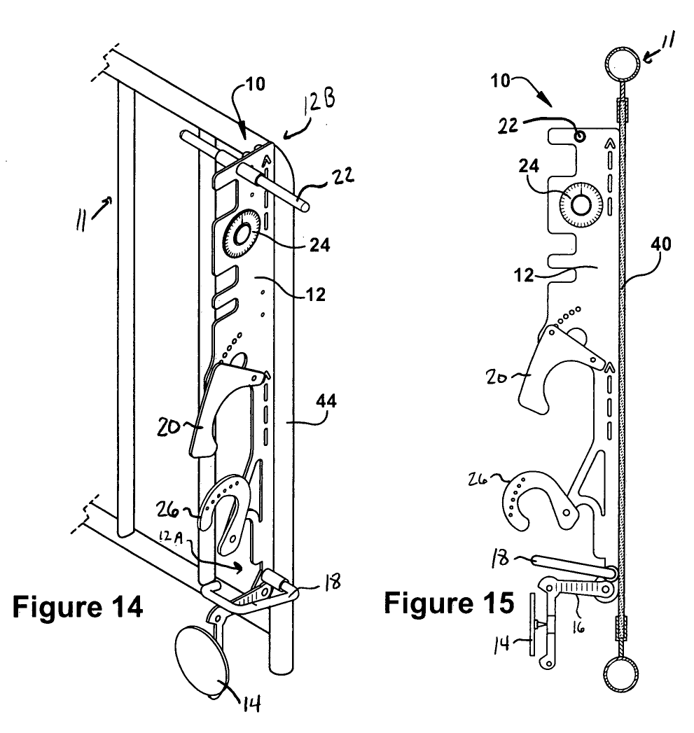

FIGS. 14 and 15 illustrate an embodiment of a handrail gauge 10 arranged to determine if a center post 44 or a glass panel 40 is installed perpendicular to a horizontal plane, i.e., installed at a true vertical plumb. The operator may position the handrail gauge 10 along a center post 44 (shown in FIG. 14) or along a glass panel 40 (as shown in FIG. 15). The gauge level dial 24 may be arranged with markings to indicate when the handrail gauge 10 is positioned perpendicular to a horizontal plane. The operator may observe the gauge level dial 24 as the handrail gauge 10 is positioned along a center post 44 or a glass panel 40 to determine if the post 44 or panel 40 is installed vertically. If the post 44 or panel 40 is not vertical, the gauge level dial 24 may be arranged to indicate the angle of the post 44 or panel 40 with respect to true vertical plumb.

The invention has been described above and, obviously, modifications and alternations will occur to others upon a reading and understanding of this specification. The claims as follows are intended to include all modifications and alterations insofar as they come within the scope of the claims or the equivalent thereof.

I claim:

1. A handrail testing device comprising:
a lever arm having a first end and a second end;
a mounting portion connected to said lever arm and capable of pivotally securing said first end on or near a handrail;
a load portion connected to said lever arm and capable of engaging said handrail to transmit a force applied to said second end of said lever arm to the handrail; and
a measurement portion connected to said lever arm.

2. The handrail testing device of claim 1 wherein said lever arm is substantially horizontally oriented when said first end is pivotally secured on or near said handrail.

3. The handrail testing device of claim 2 wherein said mounting portion is capable of engaging a wall adjacent said handrail to pivotally secure said first end.

4. The handrail testing device of claim 1 wherein said lever arm is substantially vertically oriented when said first end is pivotally secured on or near said handrail.

5. The handrail testing device of claim 4 wherein said mounting portion is capable of engaging a picket connected to said handrail to pivotally secure said first end.

6. The handrail testing device of claim 1 wherein said measurement portion comprises:
a first indentation having a diameter representative of a maximum diameter for said handrail; and
a second indentation having a diameter representative of a minimum diameter for said handrail.

7. The handrail testing device of claim 1 wherein said measurement portion is capable of measuring the clearance between said handrail and a wall.

8. The handrail testing device of claim 1 wherein said measurement portion is capable of measuring the distance between pickets of said handrail.

9. The handrail testing device of claim 1 wherein said measurement portion has a length representative of a maximum distance between two pickets connected to said handrail.

10. The handrail testing device of claim 1 wherein said mounting portion has a length representative of a maximum distance between two pickets connected to said handrail.

11. The handrail testing device of claim 1 wherein said measurement portion is capable of measuring the height of said handrail.

12. The handrail testing device of claim 11 wherein said measurement portion is extendable from said lever arm such that the combined length of said measurement portion and said lever arm is representative of a maximum distance between two pickets connected to said handrail.

13. The handrail testing device of claim 1 further comprising a level indicator capable of measuring the levelness of said handrail.

14. A handrail testing device comprising:
a lever arm having a first end and a second end;
a first mounting portion connected to said lever arm and capable of pivotally securing said first end of said lever arm on or near a handrail;
a first load portion connected to said lever arm, wherein a force applied to said second end of said lever arm is transmitted from said first load portion to said handrail;
a second mounting portion connected to said lever arm and capable of pivotally securing said first end of said lever arm on or near said handrail; and
a second load portion connected to said lever arm, wherein a force applied to said second end of said lever arm is transmitted from said second load portion to said handrail.

15. The handrail testing device of claim 14 wherein said first mounting portion is capable of engaging a wall adjacent said handrail to pivotally secure said first end.

16. The handrail testing device of claim 14 wherein said second mounting portion is capable of engaging a picket connected to said handrail to pivotally secure said first end.

17. The handrail testing device of claim 14 further comprising a bracket member capable of engaging said handrail to position said lever arm along said handrail.

18. The handrail testing device of claim 14 further comprising a gauge connected to said lever arm capable of indicating the force applied to said handrail.

19. The handrail testing device of claim 14 further comprising a handle connected to said lever arm.

20. The handrail testing device of claim 19 wherein said handle is extendable.

21. The handrail testing device of claim 14 wherein said lever arm is substantially horizontally oriented when said first end is pivotally secured with said first mounting portion.

22. The handrail testing device of claim 14 wherein said lever arm is substantially vertically oriented when said first end is pivotally secured with said second mounting portion.
